(19) United States
(12) Patent Application Publication
(10) Pub. No.: US 2017/0287455 A1
(43) Pub. Date: Oct. 5, 2017

(54) Musical Instrument Cover System

(71) Applicants: Donald Douglas Gandy, Reno, NV (US); Nahrin Aviz Gandy, Reno, NV (US)

(72) Inventors: Donald Douglas Gandy, Reno, NV (US); Nahrin Aviz Gandy, Reno, NV (US)

(21) Appl. No.: 15/477,809

(22) Filed: Apr. 3, 2017

Related U.S. Application Data
(60) Provisional application No. 62/317,099, filed on Apr. 1, 2016.

(51) Int. Cl. G10G 7/00

(52) U.S. Cl. CPC G10G 7/00; G10D 1/085

(57) ABSTRACT

An apparatus for covering a musical instrument such as a guitar. The system comprises a back section and a front section with each of the back and front sections being affixed along a lateral edge to a side section. The cover is formed with an interior area into which the musical instrument is inserted. The musical instrument is protected from damage in the event the instrument is mishandled, dropped or knocked into another object. Cut-outs in the sections provide access to the components of the instrument for a musician to access such components while playing the instrument with the cover system in place.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

This invention relates to devices and systems for the protection of musical instruments from damage caused by scratching, denting, drops, regular wear and tear, or other minor or major actions that may adversely impact the external components and finish of the instrument.

Musical instruments are regularly transported or stored in cases into which the instrument is placed for safekeeping. Cases can be hard-shelled or soft-shelled and are usually configured to cover the entirety of the instrument. Cases are not designed to allow a musician to play an instrument while the instrument is in the case. Therefore, when the instrument is removed so it can be played, it is exposed to potentially damaging actions. For example, an instrument may be mishandled or dropped, it might be banged into another object or another object may be banged into it. An instrument could also be scratched or damaged by the musician during use. For example, a guitarist using a pick could inadvertently scratch the guitar body or a violinist might accidentally hit the body of the violin with the bow. For these types of actions, as well as a variety of others, it is desirable to use a protective system to cover the body and other key components of a musical instrument while it is being played.

### SUMMARY

The present invention provides a system for protecting a musical instrument while it is being played or handled. The system may be implemented in hard-shell or soft-shell form and is custom fitted to each individual instrument. In hard-shell form, the protective system is made of semi-rigid rubber or plastic, and includes a soft interior liner that contacts the body of the instrument. The protective system is configured to flex outwardly and over the sides of the instrument, and snap securely into place. Once in place, the system fits tightly against the instrument with the interior liner of the case contacting the body of the instrument to avoid any rubbing or other motion between the instrument and the system that might otherwise cause damage.

In soft-shell form, the protective system may be made of neoprene, nylon, fabric or other flexible material that is soft, but may retain an overall shape the corresponds to the shape of the instrument it is designed to protect. Like the hard-shell embodiment, the soft-shell system includes a soft interior liner that contacts the body of the instrument. The system may be pulled or stretched over the instrument until it is fitted into place. Once in place, the system fits tightly against the instrument with the interior liner of the case contacting the body of the instrument to avoid any rubbing or other motion between the instrument and the system that might otherwise cause damage.

### BRIEF DESCRIPTION OF THE DRAWINGS:

For a better understanding of the present invention, and to show more clearly how it is configured and functions, reference will now be made, by way of example, to the accompanying drawings. The drawings show embodiments of the present invention in which:

FIG. 1 shows a musical instrument in the form of an electric guitar with which the present invention is used;

FIG. 2 is a front view of an electric guitar with the musical instrument cover system in place over the guitar body; and

FIG. 3 is a close-up front view of an electric guitar with the musical instrument cover system in place over the guitar body;

FIG. 4 is a back view of an electric guitar with the musical instrument cover system in place over the guitar body;

FIG. 5 is a side perspective view of an electric guitar with the musical instrument cover system in place over the guitar body;

FIG. 6 is a side view of an electric guitar with the musical instrument cover system in place over the guitar body;

FIG. 7 is a side perspective view of an electric guitar with the musical instrument cover system in place over the guitar body;

FIGS. 8 is a perspective view of hard-shell musical instrument cover system that fits over the body of a musical instrument;

FIG. 9 is a perspective view of a shell portion of the hard-shell musical instrument cover system of FIG. 8;

FIG. 10 show a front view of a cover portion of the hard-shell musical instrument cover system of FIG. 8 that fits over an opening of the shell portion of the musical instrument cover system of FIG. 9;

FIGS. 11A-C show views of a lip and tongue combination for holding a cover section in place over a hard-shell cover; and

FIG. 12 is an alternative embodiment showing a tab/slot mechanism for holding a cover section in place over a hard-shell cover.

### DETAILED DESCRIPTION

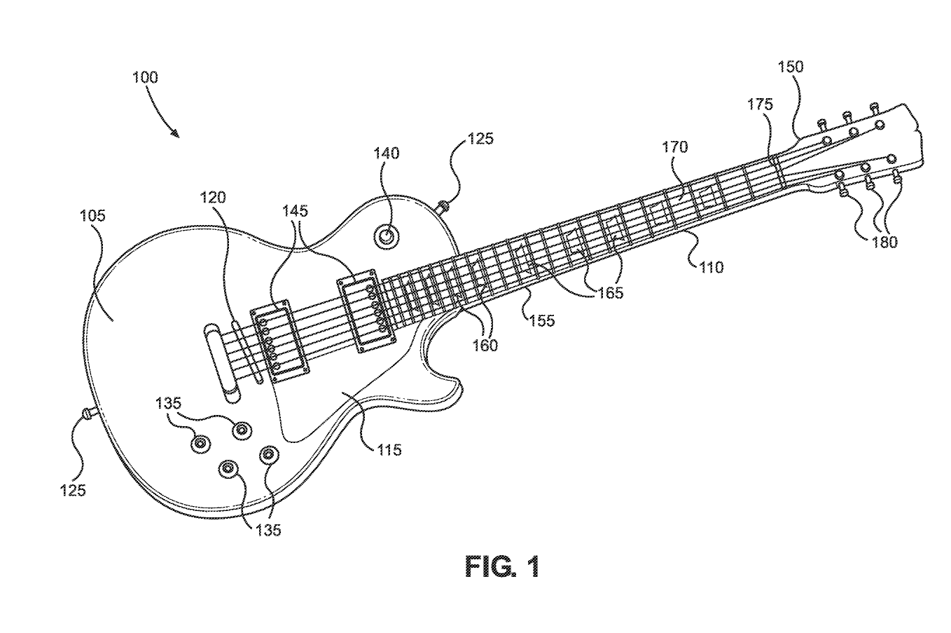

The present invention will now be described more fully with reference to the accompanying drawings. It should be understood that the invention may be embodied in many different forms and should not be construed as limited to the embodiments set forth herein. Throughout the FIGS. 1-12, like elements of the invention are referred to by the same reference numerals for consistency purposes.

FIG. 1 is a musical instrument in the form of a prior art guitar 100. Guitar 100 has a body 105 and a neck 110. Body 105 houses a number of other parts including a pick guard 115, a bridge 120, a strap buttons 125, an input jack 130, volume and tone controls 135, pickup selector 140, and pickups 145. A head 150 is positioned at the end of neck 110 and a number of components are located on neck 110 including fret board 155, frets 160 and fret markers 165. A set of strings 170 are attached at one end to body 105. Strings 170 cross bridge 120, extend along neck 110, over string guides 175 at the end of neck 110, and are attached at the other end to adjustable tuners 180 mounted to head 155.

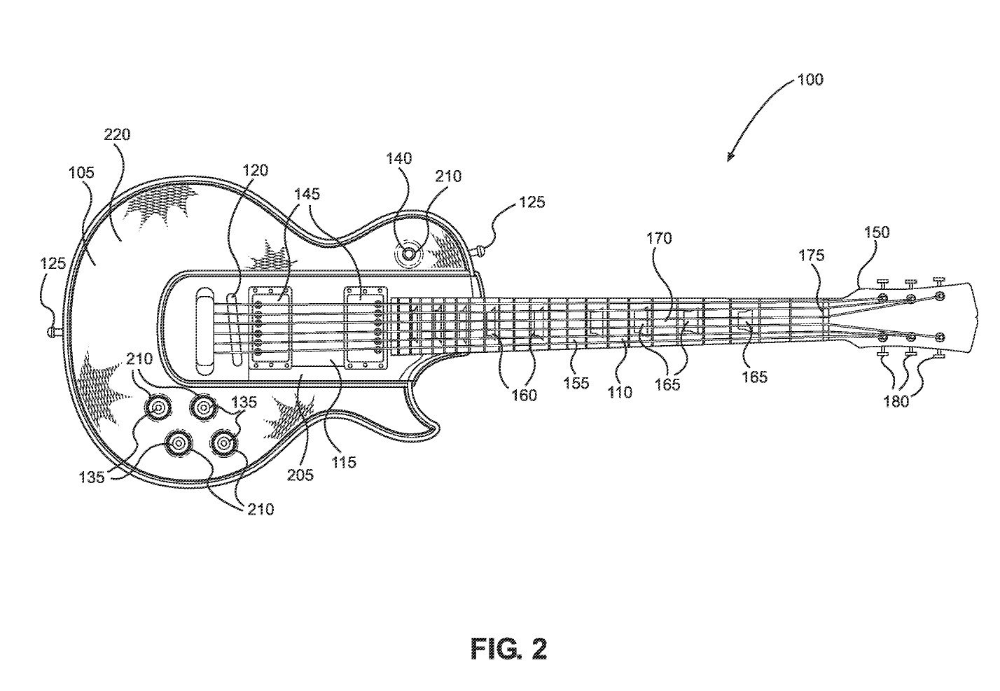

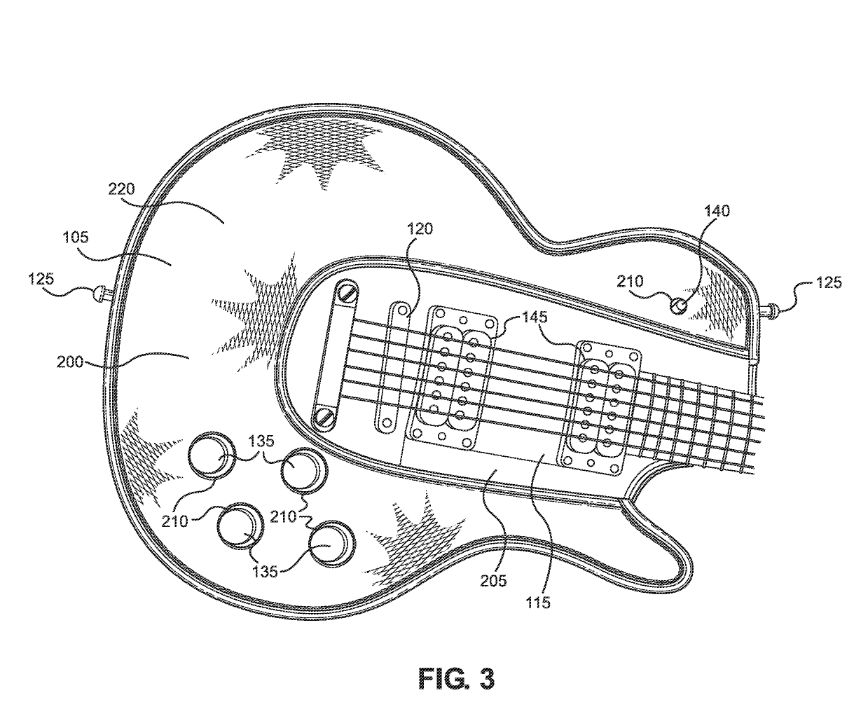

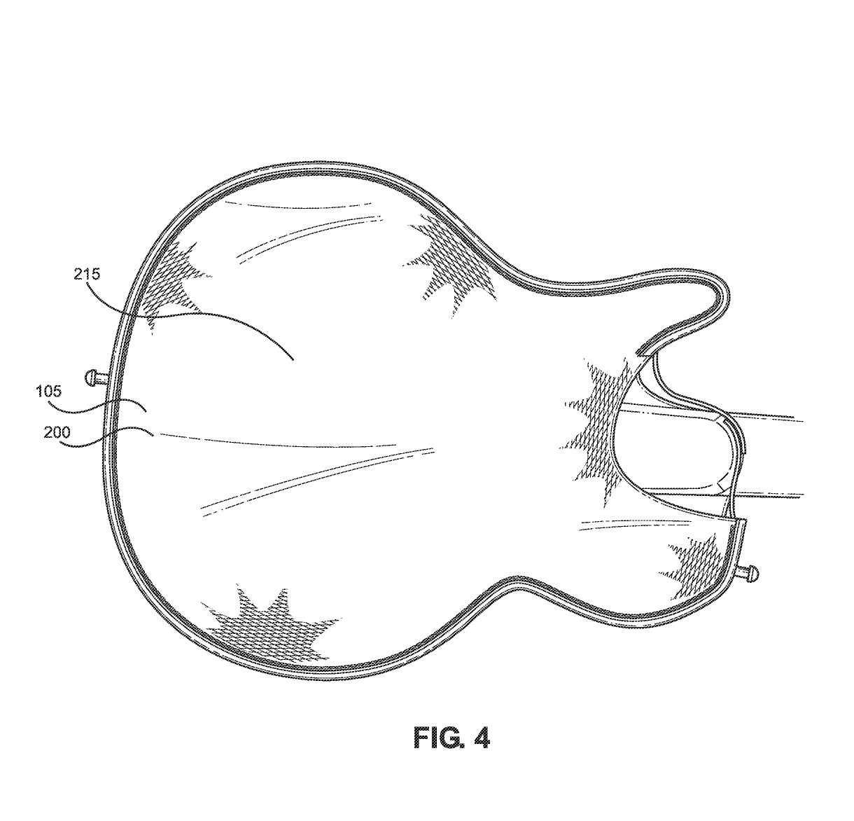

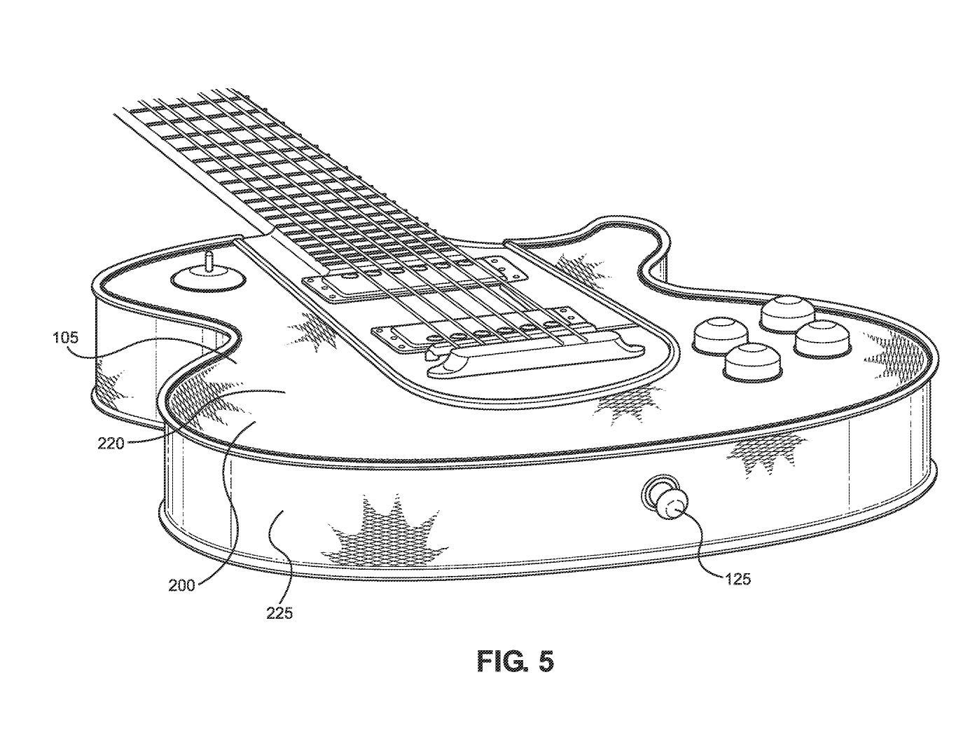

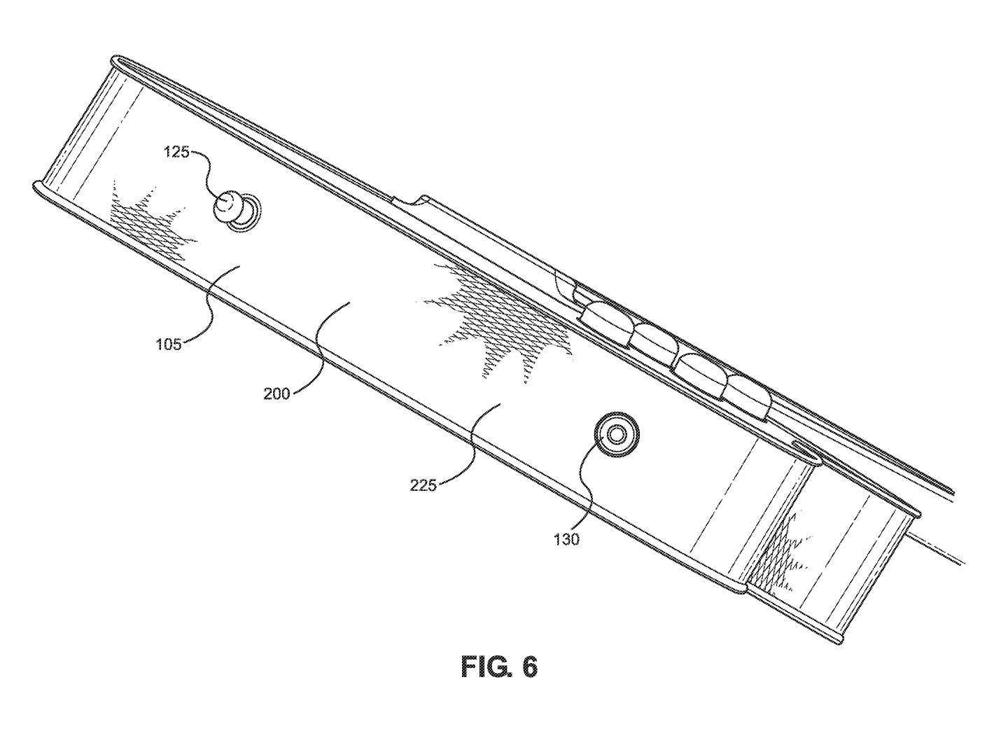

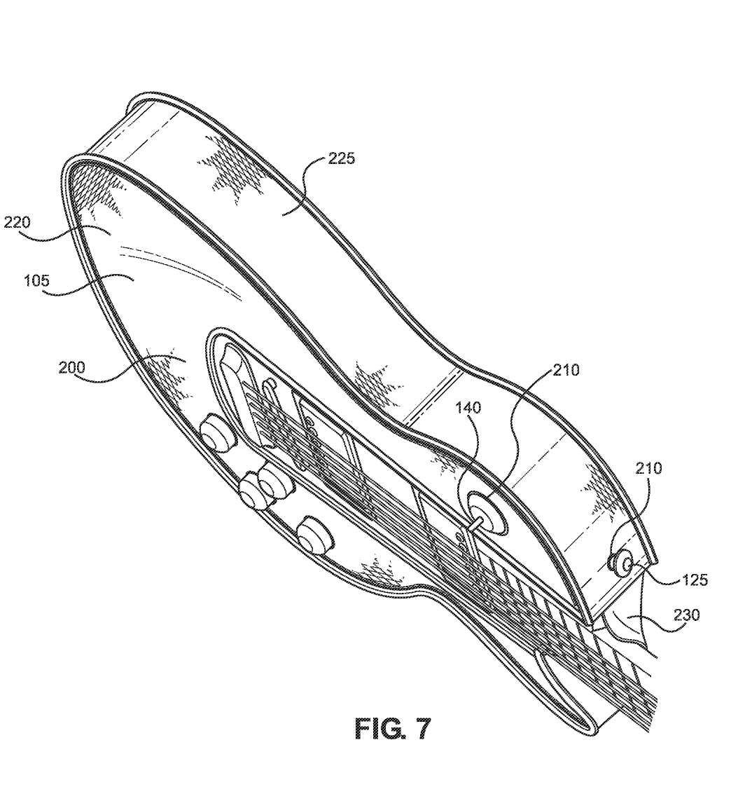

FIGS. 2-7 show five views of guitar 100 covered by a soft-shell musical instrument cover 200: FIG. 2 is a front view; FIG. 3 is a close-up front view; FIG. 4 is a back view; FIG. 5 is a side perspective view of an electric guitar with the musical instrument cover system in place over the guitar body; FIG. 6 is a side view of an electric guitar with the musical instrument cover system in place over the guitar body; and FIG. 7 is a side perspective view of an electric guitar with the musical instrument cover system in place over the guitar body. In describing musical instrument cover 200, reference to all eight figures is made. As can be seen in FIGS. 2-7, soft-shell musical instrument cover 200 covers a partial area of body 105 of guitar 100 and is shaped to conform to the shape of body 105. Soft-shell cover 200 includes a cut-out area 205 exposing the section of body 105 around strings 170 and including bridge 120, pickups 145 and the portion of neck 110 that attaches and overlays body 105.

Other cut-outs 210 in soft-shell material at corresponding positions provide access to strap buttons 125, input jack 130, volume and tone controls 135 and pickup selector 140. Optionally, the cut-outs 210 around the volume and tone controls 135 may be configured to accommodate several positions of the volume and tone controls 135. For example, the cut-outs 210 around the volume and tone controls 135 may include a slit in the soft-shell cover at two sides of the cut-outs 210 around the volume and tone controls 135. Additionally, the cut-outs 210 around the volume and tone controls 135 may be slightly larger than the actual volume and tone controls 135. Further, the soft-shell cover 200 optionally includes an additional cut-out area that exposes the volume and tone controls 135. This additional cut-out area is reinforced with additional stitching around the outside of the additional cut-out area. Alternatively, there are no cut-outs around the volume and tone controls 135. In this alternative embodiment, a user may create their own cut-outs around the volume and tone controls 135 in order to match the particular configuration of the volume and tone controls 135 on their musical instrument.

Guitars and other musical instruments have several configurations. In order to firmly secure the soft-shell cover 200, in particular in configurations such as those shown in FIGS. 2-7, a strap across the cut-out area 205 is included in the soft-shell cover 200. This particular body configuration, with one horn and a curved portion, is susceptible to the soft-shell cover 200 slipping. The strap secures the soft-shell cover 200 to prevent this slipping, so the soft-shell cover does not interfere with the playing of the musical instrument. The strap is secured to one side of the cut-out area 205 securely. The secure attachment includes stitching or other non-removable attaching mechanisms. The strap is secured to the other side of the cut-out area 205 detachably. The detachable attachment includes Velcro® or other removable attaching mechanisms. The strap passes under the strings 170 and between the pickups 145, such that the strap does not interfere with the playing of the musical instrument.

Soft-shell cover 200 is formed of any soft material that can be cut and joined, stitched or otherwise attached in different patterns, and that has at least some stretchable characteristics. The material may be neoprene, cotton, nylon, polyester, leather, vinyl or any other suitable fabric. Preferably, soft-shell cover 200 is slightly padded to a thickness in a typical range of 2-4 mm, achieved by incorporating a soft interior liner that may be foam, neoprene, rubber, vinyl, felt, cotton or another soft material having thickness and cushioning for protection. The padding may be configured to be thicker or thinner in different areas of the cover as desired. For example, where a belt buckle of a musician's belt typically comes into contact with the back section of a guitar. In soft-shell form, cover 200 is formed of at least three individual sections. A first section forms the back portion 215 visible in FIG. 4. As can be seen in this view, the back portion is shaped to match the back of the guitar or other musical instrument. A second section forms the front portion 220 visible in FIGS. 2, 3 and 5, and is shaped to match the front of the guitar with appropriate cut-outs 205 and 210. A third section forms the side portion 225 visible in FIGS. 5-7. As with the first and second sections, third section 225 is shaped to match the side of the instrument with cut-outs 210.

Front section 220 and back section 215 are each stitched along a seam to the side section 225 to form cover 200 with an interior area. An opening at the end of cover 200 where neck 110 attaches to body 105 and cut-out 205 is formed provides an area into which body 105 of guitar 100 or another musical instrument can be inserted into the interior area. As guitar 100 is inserted, into the interior area, cover 200 can be pulled and stretched over body 105 of guitar 100 to provide a tight fit with the different guitar components aligning with cut-touts 205 and 210 as appropriate. An optional flap 230 extends from side section 225 and fits across the back of neck 110 where it is secured to the other end of side section 225 to hold the ends of side section 225 in place over guitar 100. Flap 230 may be permanently secured to one side while being removably attached to the other side using hook and loop fasteners or other known components for temporarily attaching flexible materials to each other. With cover 200 in place, a musician can play guitar 100 with a high level of confidence that guitar 100 is fully protected from any scratching, denting or other damage that may be caused by handling guitar 100 including normal wear and tear, handling, dropping it or inadvertently knocking it into another object.

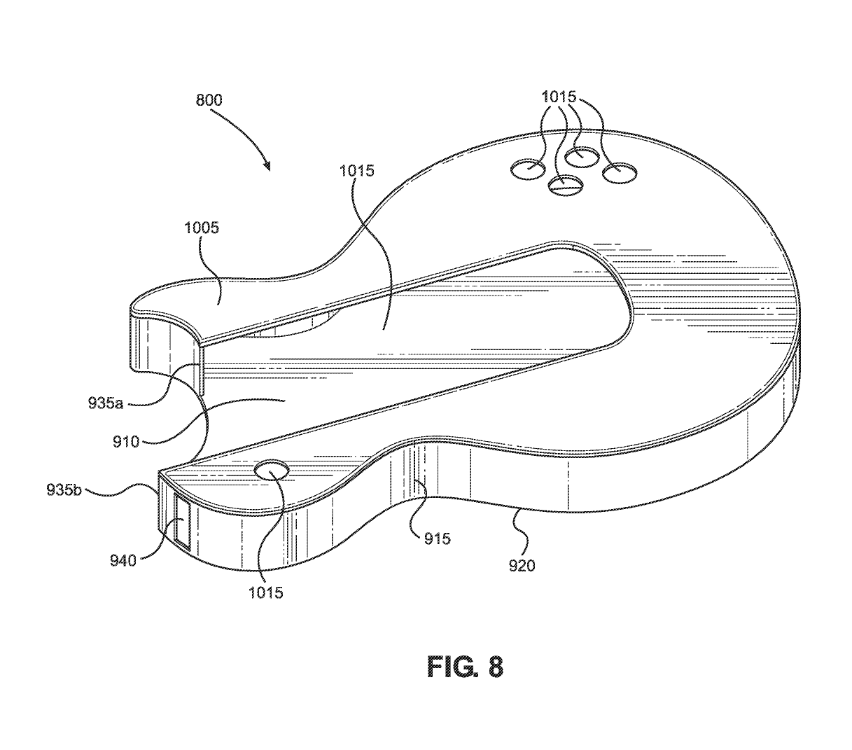

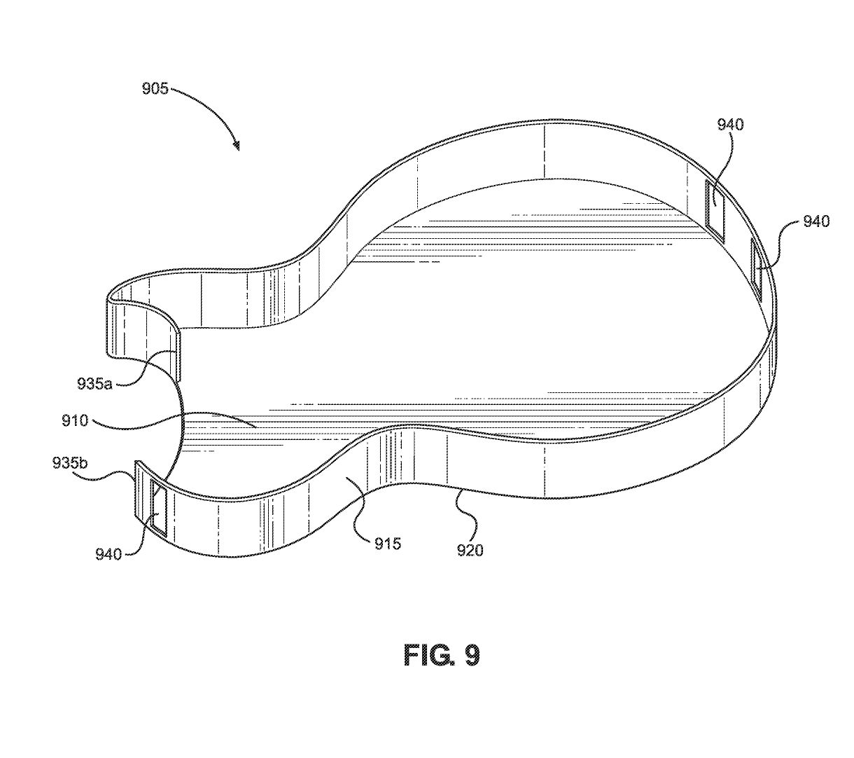

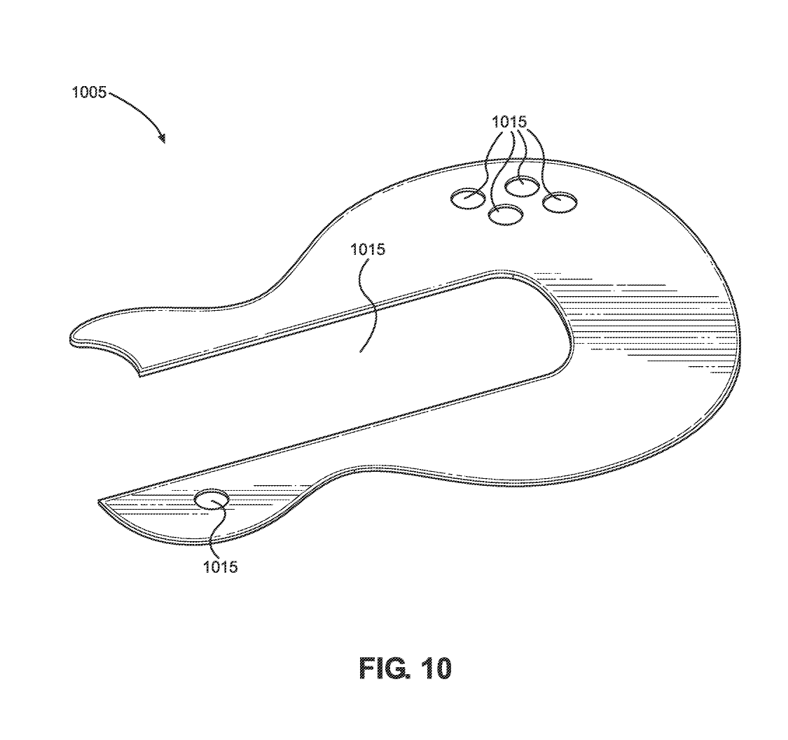

An alternative embodiment in the form of a two-piece, hard-shell musical instrument cover is shown in FIGS. 8-10. The three views of hard-shell musical instrument cover are as follows: FIG. 8 is a perspective view of hard-shell musical instrument cover system 800 that fits over body 105 of musical instrument 100; FIG. 9 is a perspective view of a shell portion 905 of the hard-shell musical instrument cover system 800 of FIG. 8; and FIG. 10 a front view of a cover section 1005 of the hard-shell musical instrument cover system 800 of FIG. 8 that fits over an opening of shell portion 905 of musical instrument cover system 800 as shown in FIG. 9. In describing hard-shell musical instrument cover 800, reference to all three FIGS. 8-10 is made.

As can be seen in FIGS. 8-10, hard-shell musical instrument cover 800 covers a partial area of body 105 of guitar 100 and is shaped to conform to the shape of body 105. Shell portion 905 is formed of a generally flat back section 910 that corresponds to the shape of the back of instrument 100. A side section 915 is shaped to correspond to the side of instrument 100 and is configured to wrap around the side of musical instrument 100. Side section 915 has a first lateral edge 920 that matches and is affixed to a portion of a lateral edge 925 of back section 910. When affixed, back section 910 and side section 915 form a hard shell with an interior space within which body 105 of musical instrument 100 fits snugly. Neck 110 of musical instrument 100 extends out of hard shell portion 905 through an open area 930 between two ends 935a, 935b of side section 915 where side section 915 does not extend along lateral edge 925 of back section 910.

Shell portion 905 includes cut-out areas 940 and cover section 1005 includes cut-out areas 1015 through which components of musical instrument 100 extend while in hard-shell cover system 800 for access by the musician playing instrument 100. For example, the section of body 105 around strings 170 and including bridge 120 and pickups 145 as well as volume and tone controls 135 and pickup selector 140 are exposed through cut-outs 1015 on cover section 1005. Cut-outs 940 in side section 915 allows access to strap buttons 125 and input jack 130.

Back section 910 and side section 915 of hard-shell portion 905, as well as cover section 1005 are formed of any semi-rigid material that can formed in different shapes, and that is malleable and somewhat flexible to snugly fit over musical instrument 100. Examples of suitable materials are (a) plastic; (b) rubber; (c) polyurethane; (d) polypropylene; (e) polycarbonate; (f) polyethylene; (g) carbon fiber; (h) fiberglass; (i) urethane; (j) silicone; (k) vinyl; or (I)any other suitable rigid or semi-rigid material that can be formed into a shape to match that of an instrument. The thickness is typically in the range of 1.75 mm-3.5 mm. And, preferably, the interior surfaces of hard-shell portion 905 and cover section 1005 are typically padded to a thickness of 2-4 mm, although it could be more or less, and is achieved by incorporating a soft interior liner that may be formed of foam, neoprene, rubber, vinyl, felt, cotton or another soft material having thickness and cushioning for protection. The soft interior liner may be glued or otherwise affixed to the entire interior surface or a significant portion of it to protect the exterior surface of musical instrument 100 from scratches or other damage when held inside of hard-shell musical instrument cover 800.

Back section 910 and side section 915 are affixed together along a corresponding shaped lateral edge on side section 920 and back section 925. An opening between ends 935a, 935b of side section 915 accommodates neck 110 in the location where neck 110 attaches to body 105. As guitar 100 is inserted into the interior area of shell portion 905, side section 915 is flexed back until strap buttons 125 on guitar 100 are inserted through cut-outs 1015. Cover section 1005 is then placed over body 105 of guitar 100 and fit into place with the different guitar components aligning with cut-outs 1015 as appropriate.

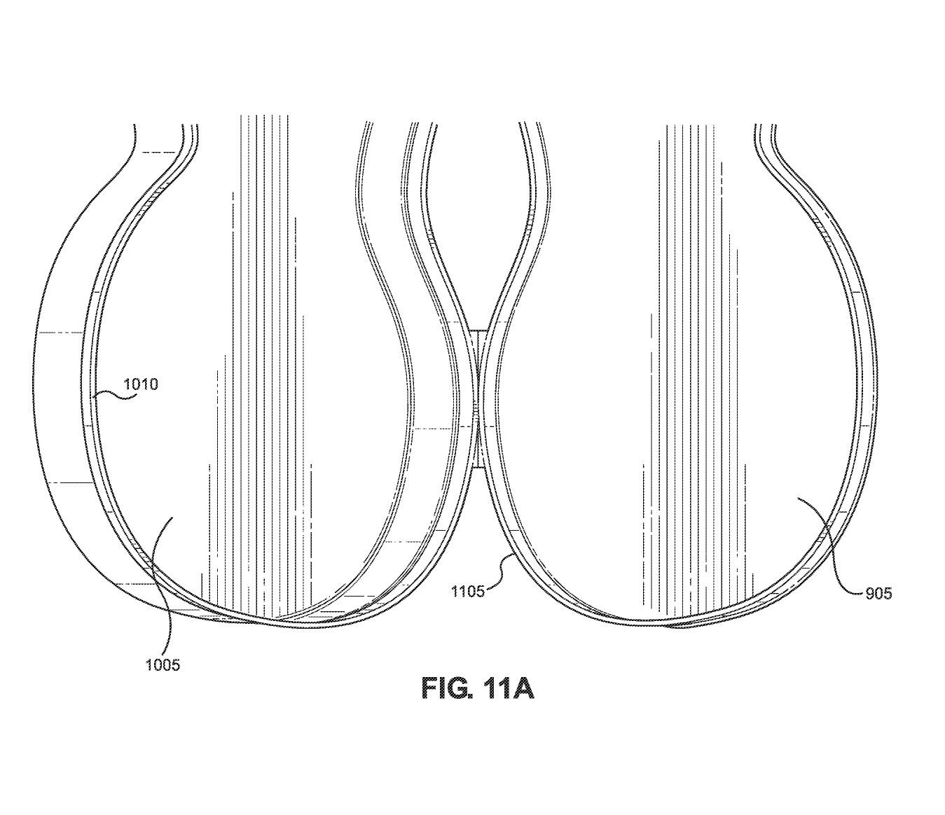

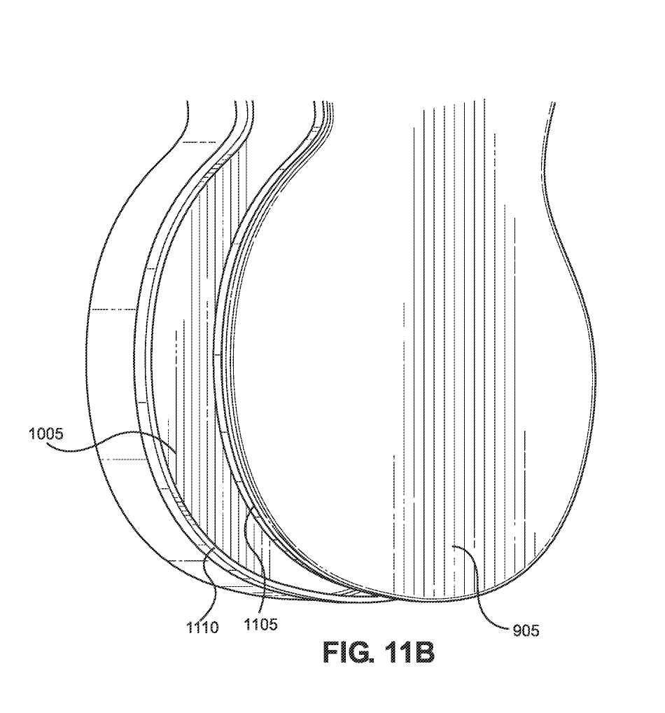

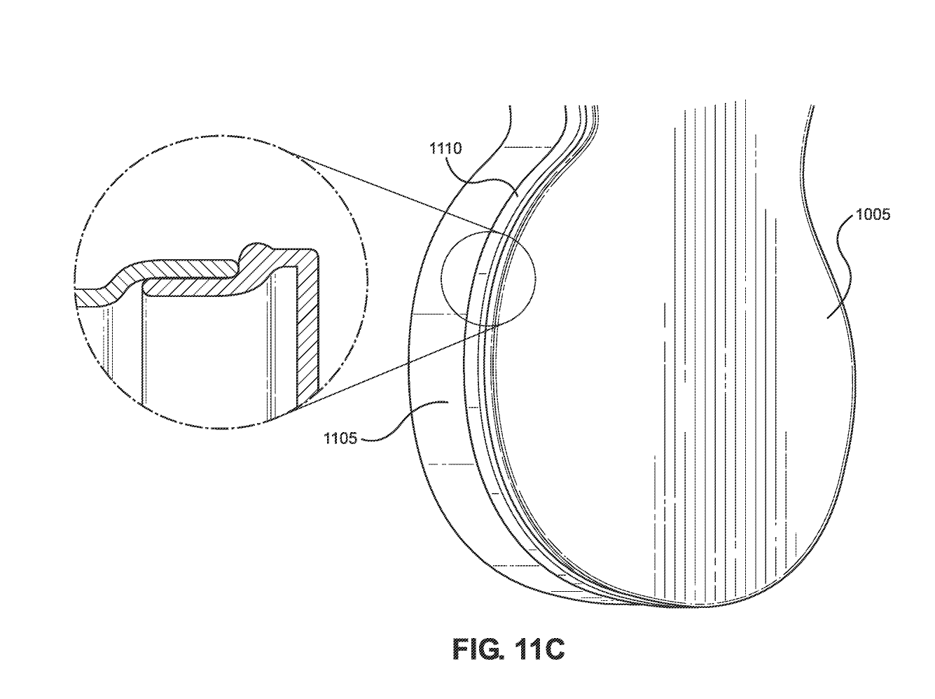

There are a number of alternative embodiments by which cover section 1005 is held in place over shell portion 905. In one embodiment shown in FIGS. 11A-C, a tongue 1105 is formed around the edge of shell portion 905. A corresponding lip 1110 matching the shape of tongue 1105 is formed at the edge of cover section 1005 so that when cover section 1005 is pressed into place over shell portion 905, lip 1110 fits securely over tongue 1105 and holds cover section 1005 securely in place on shell portion 905. It should be understood that cover section 1005 may be a separate component having lip 1105 formed around the entire periphery of cover section 1005 and shell portion 905 being configured with tongue 1110 formed around the entire periphery of shell portion 905. In another embodiment, cover section 1005 may be hinged connected to shell portion 905 such that cover section 1005 swings open to allow instrument 100 to be placed within shell portion 905 before cover section 1005 is swung into place. In this embodiment, lip 1110 and tongue 1105 are formed around only a portion of the edge of shell portion 905 and cover section 1005 respectively, and not in the portion of the edge where cover section 1005 is hinged connected to shell portion 905. To further strengthen the engagement between cover section 1005 and shell portion 905, a combination of aligned dimples, indents, other minor protrusions or may be formed in either or both of tongue 1105 and/or shell portion 905. Such formations increase the pressure between the two components to hold them together without inadvertently coming apart.

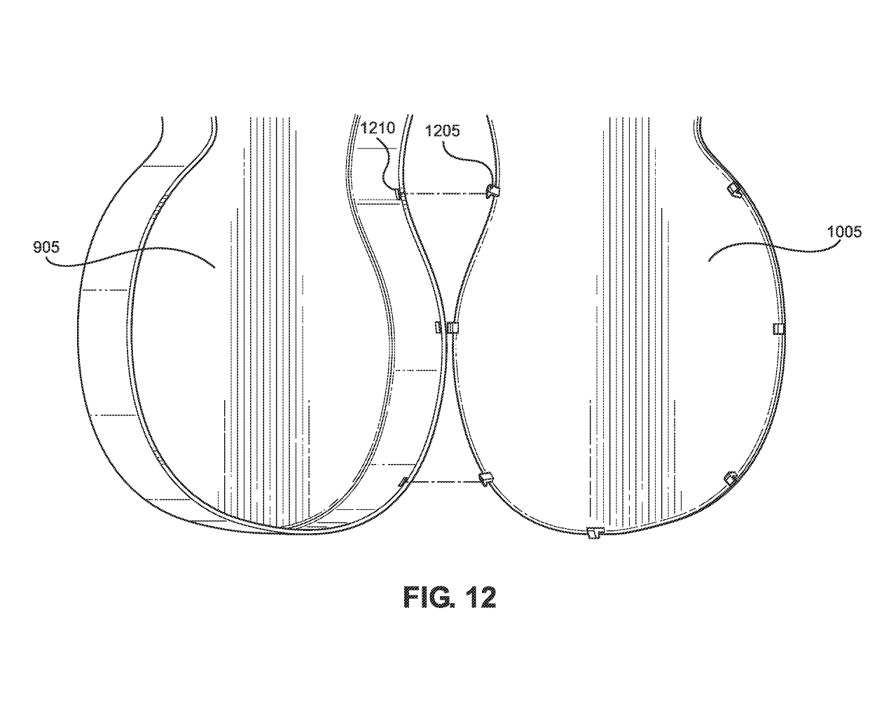

In an alternative embodiment shown in FIG. 12, tabs 1205 positioned at the edge of cover section 1005 are received in tab receiving slots 1210 on shell portion 905 or vice versa to lock cover section 1005 into place on shell portion 905. It should be understood that the number of tabs 1205 and corresponding tab receiving slots 1210 may vary and depend on the shape of hard-shell cover system 800 to ensure a stable coupling between cover section 1005 and side section 920. As in the embodiment of FIG. 11 above, a hinge may be employed along some portion of the edges of cover section 1005 and shell portion 905.

It should be understood that other attachment mechanisms may be used, including but not limited to hook and loop fastener straps, snaps, hinges, clamps, or latch system. Once cover 1005 is in place, a musician can play guitar 100 with a high level of confidence that guitar 100 is fully protected from any scratching, denting or other damage that may be caused by handling guitar 100 including dropping it or inadvertently knocking it into another object.

While the invention has been described with respect to the FIGS. 1-12, it will be appreciated that many modifications and changes may be made by those skilled in the art without departing from the spirit of the invention. Any variation and derivation from the above description and drawings are included in the scope of the present invention as defined by the claims. For example, side section 915 may be affixed to cover section 1005 to form shell portion of hard shell cover system 800 with back section 910 fitted with tabs to be placed over the back of musical instrument 100.

1. An apparatus for covering a musical instrument comprising:
a back section formed of a stretchable fabric and shaped to approximately match a back area of the musical instrument over which the apparatus is fitted:
a front section formed of the stretchable fabric and shaped to approximately match a front area of the musical instrument, the front section having at least one cut-out;
a side section formed of the stretchable fabric and shaped to approximately match the side area of the musical instrument; and
wherein, the side section is affixed along a first lateral edge to the back section and along a second lateral edge to the front section forming an interior area within which a body portion of the musical instrument fits, and further wherein each of the at least one cut-out surrounds at least a portion of one or more components of the musical instrument allowing the components to be exposed for access.

2. The apparatus of claim 1 wherein the stretchable fabric is formed of a type from the group comprising: (a) neoprene; (b) nylon; (c) cotton; (d) polyester; (e) leather; (f) vinyl; or (g) any other soft material that can be cut to a suitable shape.

3. The apparatus of claim 1 further comprising an interior liner affixed to interior surfaces of the back section, the front section and the side section.

4. The apparatus of claim 3 wherein the interior liner is made of a material from the group comprising: (a) foam; (b) neoprene; (c) cotton; (d) nylon; (e) felt; (f) polyester; (g) rubber; or (h) any other material that provides cushioning.

5. The apparatus of claim 1 further comprising a flap affixed to a first end of the side section and removably affixed to a second end of the side section.

6. The apparatus of claim 1 further comprising a strap securely attached to one side of the at least one cut-outs and detachably attached to an opposite side of the at least one cut-outs.

7. The apparatus of claim 6, wherein the strap passes under the strings of the musical instrument and between the pickups of the musical instrument.

8. The apparatus of claim 6, wherein the secure attachment of the strap comprises stitching and the detachable attachment of the strap comprises Velcro®.

9. The apparatus of claim 1, wherein the at least one cut-outs include a plurality of cut-outs around the volume and tone controls.

10. The apparatus of claim 9, wherein the plurality of cut-outs around the volume and tone controls are configure to be adjustable.

11. The apparatus of claim 10, wherein the plurality of cut-outs are adjustable by including slits in the soft-shell cover around the plurality of cut-outs.

12. The apparatus of claim 1, wherein the at least one cut-outs include an additional cut-out area that exposes the volume and tone controls, and wherein the additional cut-out area is reinforced with stitching around the outside of the additional cut-out area.

13. An apparatus for covering a musical instrument comprising:
a shell having an interior space and an opening, the shell formed of a semi-rigid material and shaped to approximately match a shape of a body of the musical instrument, the shell comprising:
a back section;
a side section having a first lateral edge and a second lateral edge, the side section being affixed to the back section along the first lateral edge; and
wherein the opening is formed substantially within the boundaries of the second lateral edge;
a cover section formed of the semi-rigid material and shaped to approximately match a front area of the musical instrument and the opening, the front section having at least one cut-out; and
wherein, the cover section removably attaches with a cover section lateral edge aligning with the second lateral edge of the side section over the opening enclosing the interior area, and further wherein each of the at least one cut-out surrounds at least a portion of one or more components of the musical instrument allowing the components to be exposed for access.

14. The apparatus of claim 13 wherein the semi-rigid material is formed of a type from the group comprising: (a) plastic; (b) rubber; (c) polyurethane; (d) polypropylene; (e) polycarbonate; (f) polyethylene; (g) carbon fiber; (h) fiberglass; or (i) any other suitable rigid or semi-rigid material that can be formed into a shape to match that of an instrument.

15. The apparatus of claim 13 further comprising an interior liner affixed to interior surfaces of the back section, the front section and the side section.

16. The apparatus of claim 15 wherein the interior liner is made of a material from the group comprising: (a) foam; (b) neoprene; (c) cotton; (d) rubber; (e) silicone; (f)

17. The apparatus of claim 13 further comprising an attachment mechanism configured to hold the cover section in place against the side section with the musical instrument in the interior space.

18. The apparatus of claim 17 further comprising:
a lip along at least a portion of the lateral edge of one of either the cover section or the side section;
a tongue along at least a portion of the lateral edge of another of either the cover section or the side section; and
wherein the tongue fits in secure contact with the lip when the cover section is placed over the opening of the shell section.

19. The apparatus of claim 18 wherein the cover section is hinged affixed to the side section along at least a corresponding portion of the lateral edge of each of the cover section and the side section.

20. The apparatus of claim 17 further comprising:
at least one protrusion along at least a portion of the lateral edge of one of either the cover section or the side section;
at least one slot along at least a portion of the lateral edge of another of either the cover section or the side section; and
wherein the at least one protrusion aligns and fits in secure contact with the at least one slot when the cover section is placed over the opening of the shell section.
